(19) United States
(12) Patent Application Publication
(10) Pub. No.: US 2003/0103310 A1
(43) Pub. Date: Jun. 5, 2003

(54) Apparatus and method for network-based testing of cluster user interface

(76) Inventor: Kenneth W. Shirriff, Redwood City, CA (US)

Correspondence Address: SUN MICROSYSTEMS INC, 901 SAN ANTONIO RD, MS PALO1-521, PALO ALTO, CA, 94303, US

(21) Appl. No.: 10/003,836

(22) Filed: Dec. 3, 2001

(51) Int. Cl. H02H 1/00

(52) U.S. Cl. 361/119

(57) ABSTRACT

Described is a technique for testing a user interface of a clustered computer system consisting of one or more cluster nodes, which are controlled by a cluster management program coupled with an administrative web server providing a user interface for the cluster management program. The testing program pre-records a sequence of requests to be sent to the administrative web server of the cluster at a later time; sends the pre-recorded sequence of requests to the administrative web server; and receives a sequence of responses of the administrative web server of the cluster to the sent pre-recorded sequence of requests. The sequence of the received responses indicates the correctness of operation of the cluster user interface. Specifically, the sequence of the received responses is compared to a sequence of expected responses corresponding to the sequence of the requests sent. The testing may also include communicating with the nodes of the cluster directly and performing direct examination of the nodes. The results of the direct examination are also indicative of the correctness of operation of the user interface.

### FIELD

The present invention relates to techniques for building and managing clustered computer systems. More specifically, the present invention relates to providing and testing a user interface for easy administration of a clustered computer system over a network, such as an Internet.

### BACKGROUND

A cluster is a collection of coupled computing nodes that typically provides a single client view of network services or applications, including databases, web services, and file services. In other words, from the client's point of view, a multinode computer cluster operates to provide network services in exactly the same manner as a single server node. Each cluster node is a standalone server that runs its own processes. These processes can communicate with one another to form what looks like (to a network client) a single system that cooperatively provides applications, system resources, and data to users.

A cluster offers several advantages over traditional single server systems. These advantages include support for highly available and scalable applications, capacity for modular growth, and low entry price compared to traditional hardware fault-tolerant systems.

If any of the nodes in the cluster fails, it is desirable that other nodes take over the services provided by the failed node such that the entire system remains operational. High Availability (HA) is the ability of a cluster to keep an application up and running, even though a failure has occurred that would normally make a server system unavailable. Therefore, highly available systems provide nearly continuous access to data and applications.

It is well known in the art that an application, such as a web server, needs to be specially configured to be able to run as a highly-available or scalable application on a computer cluster. First, the installation of the application may differ between a standalone installation and a cluster installation. Next, there must be provided a special program called a resource type, that would start an instance of the application, monitor application's execution, detect failure of the application and start another instance of the application if the first instance fails. The resource type associated with the application must be installed on the cluster. Finally, the clustering software must be configured to manage the application as an instance of the resource type. The configuration may involve creation of a resource entity to manage the application and a resource group entity to group together multiple resources. Finally, the application must be started under control of the clustering software. The term data service will be used herein to describe a third-party application such as Apache web server that has been configured to run on a cluster rather than on a single server. A data service includes the application software and special additional container process called resource type that starts, stops, and monitors the application.

The software for administration of a computer cluster ensures that critical applications are available to end users (clients) and that cluster is stable and operational. The computer cluster administration software displays cluster resources, resource types, and resource groups. It also enables the computer cluster manager to monitor the computer cluster and check the status of the cluster components such as network interfaces and storage devices. It also provides mechanism for controlling the cluster, for example, starting and stopping application services. The software may provide mechanisms for installation of cluster applications. Finally, it enables the cluster administrator to perform configuration of the cluster, such as creation of resource types, resource groups, and resources.

Due to the complexity of cluster administration, it is desirable to have a mechanism to provide a graphical user interface (GUI) for administration. This graphical user interface provides a simpler way to perform administrative tasks that typing commands on the command line, using the command-line interface (CLI). The GUI can be implemented using well-known techniques, such as menus, windows, mouse control, icons, and graphical diagrams. In addition, the administrative GUI should be accessible over a network, to permit easy administration of the computer cluster from a remote computer.

An exemplary architecture of a computer cluster administration configuration is shown in FIG. 1. In the system shown in this figure, the computer cluster administration GUI runs on a remote administrator's computer 106 over a network 104, using a browser software 105. Specifically, the cluster administration software in the computer cluster architecture shown in FIG. 1 includes an administrative web server 102 running on one or more nodes 103 of the cluster 107. This web server 102 provides information on the state of the computer cluster 107. The web server 102 also provides a cluster user interface, which can be implemented, for example, using forms that a user can fill out to perform various operations. Specifically, well-known in the art common gateway interface (CGI)—compliant forms can be utilized. The “backend” to the web server 102, designated in FIG. 1 with numeral 101, provides the data to the web server 102, processes responses from the cluster administrator, and performs the operations requested by the administrator. A communication mechanism comprising network 104 enables the backend software 101 to collect information from other nodes 103 in the cluster 107 and perform various operations on these nodes. Finally, the aforementioned browser 105 runs on a remote administrator's computer 106 and enables the cluster administrator to use remotely the graphical user interface of the cluster administration software. The browser 105 communicates with the cluster web server 102 via aforementioned network 104.

A user-interface enabled administration software for managing a cluster may implement several types of functionality including, but not limited to, installing clustering software on a set of nodes and starting the cluster running; monitoring the status of the cluster; modifying the configuration of the cluster; monitoring the performance of the system, performing administrative tasks, viewing status logs, controlling the hardware such as disks and networks, and installing and starting applications on the cluster. Such applications may include, but are not limited to, databases, web servers, directory servers, and file system servers.

One major problem with the existing cluster management software products is the need for extensive testing thereof to find potential bugs. During this testing, all operations that the product implements must be verified for correctness. Also, all the information returned to the administrator's browser by the cluster management software must be verified for correctness. In other words, it must be insured that this information accurately reflects the state of the cluster. In addition, the state of each node of the cluster must be verified for correctness. Finally, any applications started on the cluster must also be verified for correct operation.

### SUMMARY

To overcome the limitations described above, and to overcome other limitations that will become apparent upon reading and understanding the present specification, an apparatus, a method, and an article of manufacture are disclosed that test a user interface of an administration software of a cluster.

According to the invention, a sequence of requests to be sent at a later time to the administrative web server of the cluster is pre-recorded. This sequence is subsequently sent to the administrative web server of the cluster.

The received sequence of responses of the administrative web server of the cluster to the sent pre-recorded sequence of requests is used to determine if the user interface of the cluster management software operates correctly. Specifically, the sequence of the received responses indicates the correctness of operation of the cluster user interface. The sequence of the received responses may be compared to a sequence of expected responses corresponding to the sequence of the requests sent. This sequence of expected responses may be a predetermined sequence.

The inventive testing technique may also include communicating with the nodes of the cluster directly and performing direct examination of the nodes. The results of the direct examination are also indicative of the correctness of operation of the user interface.

The inventive technique may also include communicating with one or more applications running on the cluster to verify that these applications are operating correctly.

### DESCRIPTION OF THE DRAWINGS

Various embodiments of the present invention will now be described in detail by way of example only, and not by way of limitation, with reference to the attached drawings wherein identical or similar elements are designated with like numerals.

FIG. 1 illustrates an exemplary embodiment of a cluster administration architecture;

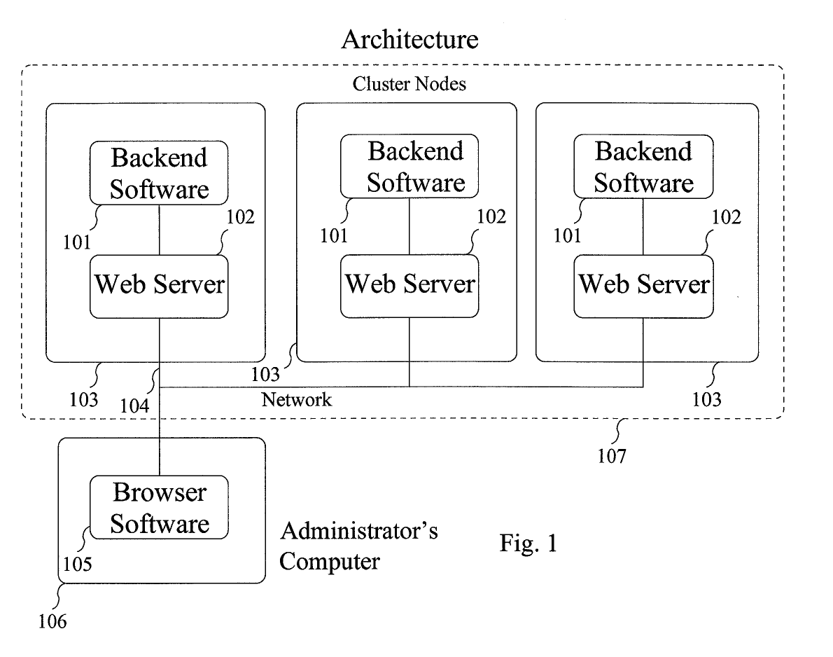

FIG. 2 illustrates an exemplary embodiment of the inventive test configuration architecture;

FIG. 3 illustrates an exemplary embodiment of the inventive test generation algorithm;

FIG. 4 illustrates an exemplary embodiment of the inventive test algorithm.

### DETAILED DESCRIPTION

To overcome the above limitations and disadvantages attributable to the existing cluster administration software, the inventive method, apparatus and article of manufacture are provided for automated testing of a cluster administration software user interface.

There exist several approaches to testing web-based systems. The first approach is manual testing. A tester sits down at a browser with a list of tests to perform, types the appropriate information into the browser, clicks the appropriate buttons with the mouse and determines whether the system performs appropriately. This type of testing is very costly in terms of person-hours, as there may be hundreds of tests to perform, and the entire test suite may need to be performed regularly, for instance after every modification or bug fix. In addition, manual testing is error-prone, as it requires a great deal of manual input from the tester, which must all be entered correctly, and the tester must visually notice any deviations from correct behavior. In addition, manual testing will not discover problems that are not visible to the tester

Another approach is a local testing. Much of the functionality of a computer cluster can be tested by running test programs on the nodes of the cluster and verifying that the operations perform correctly. However, this type of testing will not work for a user interface that is designed for operation from a system external to the cluster, since the correct behavior must be observed externally.

Finally, one can utilize web-based testing tools. There have been numerous tools developed for testing web servers for functionality and performance. Types of existing test tools include link testers that can be used to verify that all hypertext links point to valid pages, load testers checking the performance of the web server under high loads, distributed test tools providing test loads from multiple clients, browser-based test tools running on top of a browser and verifying that the browser presents the proper results, and web-based content verifiers ensuring that the server returns the proper content. While these tools can test web servers that happen to be clusters, they are unable to test the cluster-specific aspects of a web server, in particular when the web server is actually controlling the cluster. That is, they can verify that the returned content appears to be correct, but they cannot verify that the state of the cluster is correct. These tools also do not test applications that are running on the cluster that are not accessible through the web-based interface, for example a file server or directory server.

An embodiment of the present invention provides a mechanism for testing web-based user-interface tools. This embodiment comprises one or more of the inventive concepts described in detail below. Firstly, the embodiment of the inventive test mechanism may comprise a mechanism for recording a sequence of requests to the cluster web server for a replay at a later time. This mechanism is used to generate a sequence of test requests or operations to be sent to cluster nodes at the time of the actual testing. In addition to the prerecorded set of test requests, the system may include a corresponding set of responses that would diagnose the system condition. Specifically, a set of responses indicative of the correct operation of the system may be provided.

Secondly, the inventive testing mechanism may comprise a mechanism for communicating with the nodes of the cluster, specifically to manipulate and examine cluster nodes directly. This mechanism facilitates the verification of the state of each node without having to utilize the user interface of the cluster, which is being tested. As it will be appreciated by those of skill in the art, such direct verification of the cluster node state provides means for improved verification of the correct operation of the cluster user interface.

Thirdly, the inventive testing mechanism may comprise a mechanism for sending requests from a test node to the administrative web server on the cluster, receiving responses, and recording responses. The aforementioned test node may be remote with respect to the cluster and may communicate with the latter via a network. The requests sent to the administrative web server may comprise requests recorded by the aforementioned request recording mechanism, described above.

Finally, the inventive testing mechanism may also include a mechanism for comparing the responses received from the cluster administrative web server with the responses indicative of the correctness of the operation of the cluster user interface. The aforementioned responses indicative of the correctness of the user interface operation may comprise a set of predetermined responses. Specifically, this set may comprise a set of responses indicative of the correct operation of the user interface. A mechanism for communicating with applications running on the cluster to verify that they are operating correctly may also be optionally provided.

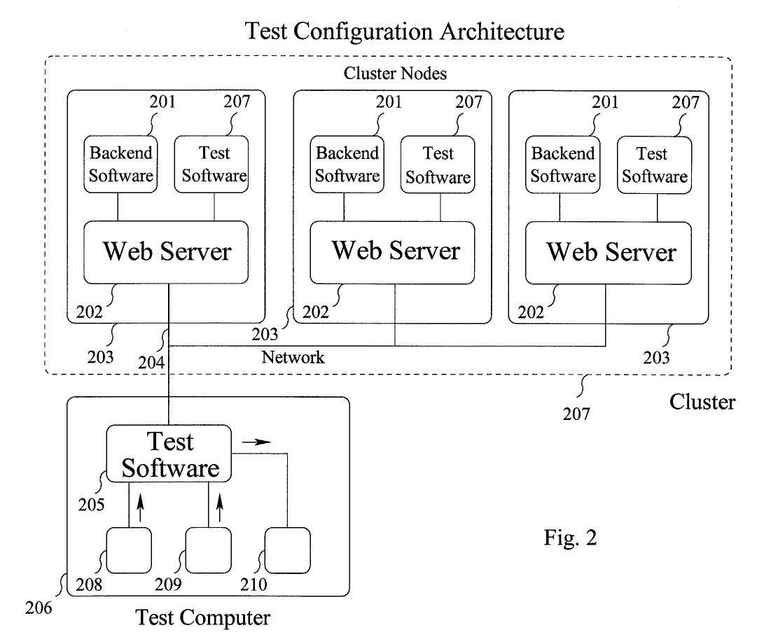

An exemplary implementation of the inventive concept is illustrated in FIG. 2. Specifically, the test computer 206 executes a test program 205 for testing a web-based user interface tools. The input test instructions for this test program 205 are taken from a file 208 containing test scripts, described below. Sets of files 209 and 210 contain desired test results and actual test results obtained. Moreover, each node 203 of the cluster 207, in addition to backend software 201, is provided with its own test software 207. This software may communicate with the test software running on the test computer 206 and may monitor the state of the cluster nodes 203. This communication can be implemented using a web server 202 connected to test computer 206 via network 204.

The initial step of an embodiment of the inventive testing technique may comprise a configuration of the test, wherein the person who performs the testing, or the test creator, uses the test software 205 to generate the aforementioned file 208 containing test scripts and the file 209 containing desired or expected test results. The terms test configuration and test generation will be used interchangeably herein, the terms desired or expected test results will, likewise, be used interchangeably.

Specifically, during the configuration process, the computer cluster is first initialized to a certain known state. The tester connects to the computer cluster via a browser and performs the sequence of operations that are desired to be tested. This sequence of operations is recorded into a file on the cluster, and each resulting web page returned to the tester is stored in a different file. The tester then verifies that each operation takes place as expected.

The tester optionally provides additional code that can be run on the nodes of the cluster to verify the nodes are in the expected state. The tester may also provide additional code that can be run on the test machine to communicate with applications running on the nodes of the computer cluster to verify that the applications are in the expected state.

The execution of the automated test will now be described in detail. First, the test machine 206 communicates with each node 302 of the cluster 207 and initializes each node 203 into a known state or condition. Then, the test machine 206 sends in sequence each recorded operation to the cluster nodes 203 and stores the resulting response in a file in set of files 210. This file is compared with the correct file in set of files 209 generated during the configuration phase of the test, whereupon the test script file was generated. If the aforementioned two files do not match, the error is recorded into a status file (not shown). Subsequently, the test machine 206, as appropriate, communicates with each node 203 of the cluster 207 and verifies that each node is in the expected state. The test machine 205 may also communicate with applications on the cluster nodes 203 to verify that they are operating correctly.

At the conclusion of the test, the tester is informed of any errors. For any files that do not match, the invention allows the tester, for example, to view the expected file and the received file side-by-side in a browser for comparison.

During the automated execution of the test, the test machine 203 may modify the recorded operations stored in file 208 before sending them to the cluster 207. For example, if the test entries of the test script file were recorded for a cluster having a node named phys-ticket-1, but the actual testing is to be performed on a cluster having a node named phys-merak-1, during the automated execution, the test software 205 may alter the entries in the test script file 208 to account for the change in the cluster node names. This could be indicated in the test file by, for instance, using a variable to use the node name or performing a pattern match on the original node name. By replacing the name “phys-ticket-1” with “phys-merak-1” in the information sent to the cluster, and performing the same substitution on the recorded expected data, the test software 205 is able to utilize the same recorded sequence of operations stored in file 208 for performing test on clusters with different descriptive characteristics.

In another embodiment of the aforementioned step 2, the comparison of the received file and the expected file may ignore differences in data that is expected to change from test to test. For instance, one cluster operation may display the amount of time the cluster has been running. This information will change, of course, between one run of the test and another, but should not be considered an error.

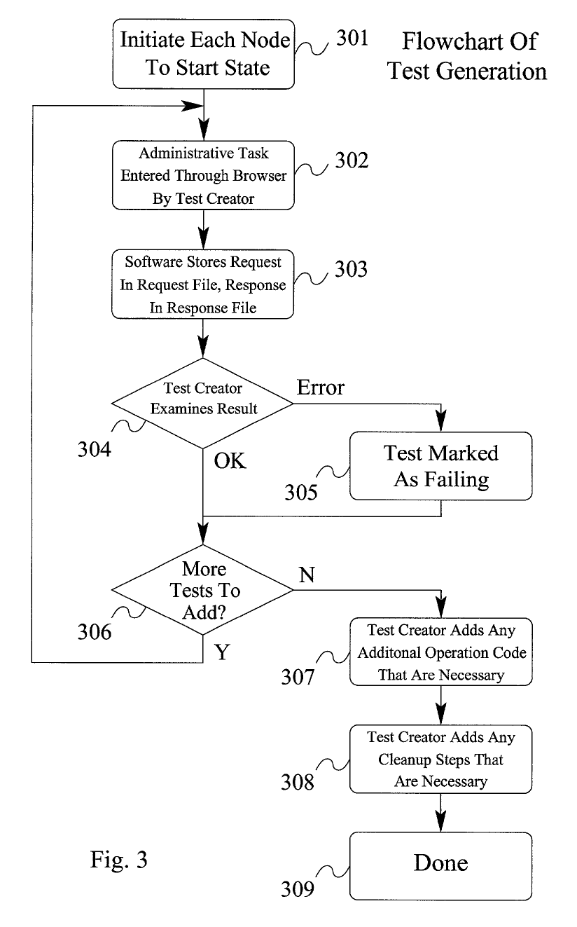

The test generation algorithm is shown in FIG. 3. Upon the beginning of the execution, the test software initiates each node of the cluster into a start state, see 301 of FIG. 3. Subsequently, an appropriate administrative task is entered by test creator using the browser running on the test computer. Each entered task may test one particular aspect of cluster operation, such as correct operation of scalable or failover resources. At 303 the test software stores requests in the request file and corresponding responses in the response file. The result is shown to the test creator at 304. If at 304 the test creator determines that the test contains an error, the test is marked as failing at 305.

If more tests need to be added at 306, the execution of the algorithm resumes at 302. After all the tests are generated, the test creator may add any additional operation code that may be necessary. Finally, at 308, the test creator adds any required cleanup steps. As mentioned above, such cleanup steps may be required to place all nodes of the cluster into a consistent state before the next test. The operation of the algorithm terminates at 309.

In an exemplary embodiment of the invention, the testing of the computer system is performed using a test script file. While the format of this file and the exact format of the data entries therein is not critical to the inventive concept described herein, one exemplary embodiment of the invention has the test script file comprising entries or lines of three types: (1) lines indicating request to be sent to the cluster administrative tool; (2) entries or lines indicating check operation to be sent to the cluster node; and (3) entries or lines indicating cleanup instructions or other internal operations for the nodes.

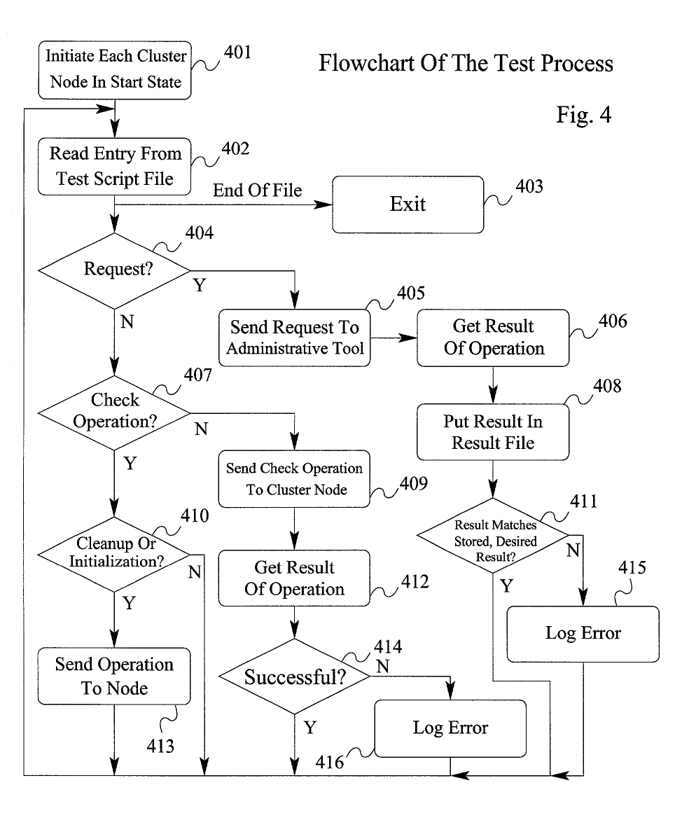

Typical algorithm for parsing the script file and executing the test commands contained therein using the exemplary test script file 208 of FIG. 2 is illustrated in FIG. 4. Specifically, at 402 the test software 207 installed in each node of the cluster initiates the nodes into initial start state. This can be done in response to a command from a test software 205 installed on administrator's computer 206 of FIG. 2. Alternatively, the initiation of the cluster nodes can be done using test software 205 without participation of the test software 207 of the cluster nodes 203, see FIG. 2. Subsequently, at 402 the test software 205 reads a line or entry from the test script file 208 and examines the instruction embodied therein.

If at 404 the test software determines that the line indicates the request to the administrative tool of the cluster, the test software transmits the appropriate request to the administrative tool running on all cluster nodes 203 through network 204, see FIG. 2. The administrative tool software running on each node 203 of the cluster 207 executes the request on one or more nodes of the cluster and sends the result of the request execution via network 204 back to the Administrator's computer 206. The test software 205 running on the administrator's host 206 receives the request execution result and at 408 of FIG. 4 stores this result in a file for storing obtained request execution results in the set of files designated with numeral 210 in FIG. 2.

Subsequently, at 411, the obtained result stored in result file in set 210 is compared with desired results stored in a file in set 209 of FIG. 2. The aforementioned file from set 209 stores results corresponding to the execution of commands from the test script 402 on a correctly operating system.

If the aforementioned comparison detects a discrepancy, which can be attributed to faulty operation, the error is logged at 415. Then, the test software causes the reading of the next line or entry from the test script file at 402.

On the other hand, if at 404 the software determines that the read line or entry does not correspond to a request instruction, the test software verifies at 407 if the read line or entry corresponds to a check operation. If it does, at 408 of FIG. 4 the test software running on the administrator's computer 206 sends the read check instruction to the cluster nodes 203 through network 204. The test software 207 operating on cluster nodes 203 executes the aforementioned check operation. Said check operation may be used to verify the state of the cluster nodes. The result of the check operation containing information on the state of the cluster nodes is sent back to the test software 205. If the test is not successfully, an error entry is added to the error log file. The unsuccessful completion of the test operation may indicate that a particular cluster node is not in a state that is expected after the test software performs a specific test request using the administrative tool of the cluster.

Finally, at 410 the test software 205 may determine that the line or entry read from the test script file indicates a cleanup or initialization operation on the cluster. In this case, the read operation is sent to appropriate nodes 203 of the cluster 207. This cleanup or initialization operation is needed to insure that the nodes of the cluster are in correct state before any subsequent test is performed.

While the invention has been described herein with reference to preferred embodiments thereof, it will be readily apparent to persons of skill in the art that various modifications in form of detail can be made with respect thereto without departing from the spirit and scope of the invention as defined in and by the appended claims. For example, the present invention is not limited to web-based testing. The inventive concept of automated testing of the cluster administration software user interface can apply to other network architectures based on a wide variety of network communication protocols. Finally, the specific format and content of the files storing the test scripts and expected test results is also not critical to the invention. All the data, including, but not limited to, requests or responses as used by the inventive test technique in the manner described above, may be stored in a magnetic or optical disk file, in a semiconductor memory, including RAM or ROM or any other suitable data storage media.

1. A method for testing a user interface of an administration software of a cluster, said cluster comprising at least one node, said cluster administration software running on said at least one node, said cluster comprising an administrative web server running on said at least one node and providing said user interface for said cluster administration software, said method comprising:
(1) pre-recording a sequence of requests to be sent to said administrative web server of said cluster at a later time;
(2) sending said prerecorded sequence of requests from a test node to said administrative web server of said cluster; and
(3) receiving a sequence of responses of said administrative web server of said cluster to said sent pre-recorded sequence of requests; wherein said sequence of received responses is indicative of correctness of operation of said user interface.

2. The method of claim 1, further comprising:
(4) communicating with one or more nodes of said cluster and performing direct examination of said one or more nodes; wherein results of said direct examination are indicative of correctness of operation of said user interface.

3. The method of claim 1, wherein said receiving said sequence of responses further comprises comparing said sequence of received responses with a sequence of expected responses.

4. The method of claim 3, wherein said sequence of expected responses comprises a subset of responses attributable to correct operation of said user interface.

5. The method of claim 3, wherein said sequence of expected responses comprises at least one pre-determined response.

6. The method of claim 1, further comprising:
(5) communicating with one or more applications running on said cluster to verify that said one or more applications are operating correctly.

7. The method of claim 1, wherein said pre-recording a sequence of requests comprises:
(a) requesting a test creator to input an administrative task; and
(b) storing said sequence of requests in a request file; said sequence of requests being determined by the administrative task input by said test creator.

8. The method of claim 7, further comprising:
(c) storing a sequence of expected responses in a response file, wherein each of said sequence of expected responses corresponds to at least one request from said sequence of requests stored in said request file.

9. The method of claim 8, further comprising:
(d) providing said test creator with an opportunity to examine said sequence of requests and said sequence of responses and mark said pre-recorded sequence of requests as failing.

10. The method of claim 7, further comprising:
(c) providing said test creator with an opportunity to add any additional operation code.

11. The method of claim 7, further comprising:
(c) providing said test creator with an opportunity to add additional cleanup steps, said additional cleanup steps ensuring that said at least one node of said cluster are placed in a consistent state after said testing is completed.

12. A computer-readable medium embodying a program for testing a user interface of an administration software of a cluster, said cluster comprising at least one node, said cluster administration software running on said at least one node, said cluster comprising an administrative web server running on said at least one node and providing said user interface for said cluster administration software, said program comprising:
(1) pre-recording a sequence of requests to be sent to said administrative web server of said cluster at a later time;
(2) sending said pre-recorded sequence of requests from a test node to said administrative web server of said cluster; and
(3) receiving a sequence of responses of said administrative web server of said cluster to said sent pre-recorded sequence of requests; wherein said sequence of received responses is indicative of correctness of operation of said user interface.

13. The computer-readable medium of claim 12, wherein said program further comprises:
(4) communicating with one or more nodes of said cluster and performing direct examination of said one or more nodes; wherein results of said direct examination are indicative of correctness of operation of said user interface.

14. The computer-readable medium of claim 12, wherein said receiving said sequence of responses further comprises comparing said sequence of received responses with a sequence of expected responses.

15. The computer-readable medium of claim 14, wherein said sequence of expected responses comprises a subset of responses attributable to correct operation of said user interface.

16. The computer-readable medium of claim 14, wherein said sequence of expected responses comprises at least one pre-determined response.

17. The computer-readable medium of claim 12, wherein said program further comprises:
(5) communicating with one or more applications running on said cluster to verify that said one or more applications are operating correctly.

18. The computer-readable medium of claim 12, wherein said pre-recording a sequence of requests comprises:
(a) requesting a test creator to input an administrative task; and
(b) storing said sequence of requests in a request file; said sequence of requests being determined by the administrative task input by said test creator.

19. The computer-readable medium of claim 18, wherein said program further comprises:
(c) storing a sequence of expected responses in a response file, wherein each of said sequence of expected responses corresponds to at least one request from said sequence of requests stored in said request file.

20. The computer-readable medium of claim 19, wherein said program further comprises:
(d) providing said test creator with an opportunity to examine said sequence of requests and said sequence of responses and mark said pre-recorded sequence of requests as failing.

21. The computer-readable medium of claim 18, wherein said program further comprises:
(c) providing said test creator with an opportunity to add any additional operation code.

22. The computer-readable medium of claim 18, wherein said program further comprises:
(c) providing said test creator with an opportunity to add additional cleanup steps, said additional cleanup steps ensuring that said at least one node of said cluster are placed in a consistent state after said testing is completed.

23. A computer system comprising at least a central processing unit and a memory, said memory storing a program for testing a user interface of an administration software of a cluster, said cluster comprising at least one node, said cluster administration software running on said at least one node, said cluster comprising an administrative web server running on said at least one node and providing said user interface for said cluster administration software, said program comprising:
(1) pre-recording a sequence of requests to be sent to said administrative web server of said cluster at a later time;
(2) sending said pre-recorded sequence of requests from a test node to said administrative web server of said cluster; and
(3) receiving a sequence of responses of said administrative web server of said cluster to said sent pre-recorded sequence of requests; wherein said sequence of received responses is indicative of correctness of operation of said user interface.

24. The computer system of claim 23, wherein said program further comprises:
(4) communicating with one or more nodes of said cluster and performing direct examination of said one or more nodes; wherein results of said direct examination are indicative of correctness of operation of said user interface.

25. The computer system of claim 23, wherein said receiving said sequence of responses further comprises comparing said sequence of received responses with a sequence of expected responses.

26. The computer system of claim 25, wherein said sequence of expected responses comprises a subset of responses attributable to correct operation of said user interface.

27. The computer system of claim 25, wherein said sequence of expected responses comprises at least one pre-determined response.

28. The computer system of claim 23, wherein said program further comprises:
(5) communicating with one or more applications running on said cluster to verify that said one or more applications are operating correctly.

29. The computer system of claim 23, wherein said pre-recording a sequence of requests comprises:
(a) requesting a test creator to input an administrative task; and
(b) storing said sequence of requests in a request file; said sequence of requests being determined by the administrative task input by said test creator.

30. The computer system of claim 29, wherein said program further comprises:
(c) storing a sequence of expected responses in a response file, wherein each of said sequence of expected responses corresponds to at least one request from said sequence of requests stored in said request file.

31. The computer system of claim 30, wherein said program further comprises:
(d) providing said test creator with an opportunity to examine said sequence of requests and said sequence of responses and mark said pre-recorded sequence of requests as failing.

32. The computer system of claim 29, wherein said program further comprises:
(c) providing said test creator with an opportunity to add any additional operation code.

33. The computer system of claim 29, wherein said program further comprises:
(c) providing said test creator with an opportunity to add additional cleanup steps, said additional cleanup steps ensuring that said at least one node of said cluster are placed in a consistent state after said testing is completed.
